(19) United States
(12) Patent Application Publication
(10) Pub. No.: US 2017/0084205 A1
(43) Pub. Date: Mar. 23, 2017

(54) Nifty Globe

(71) Applicant: Menzi Sigelagelani, Tipton (GB)

(72) Inventor: Menzi Sigelagelani, Tipton (GB)

(21) Appl. No.: 15/273,247

(22) Filed: Sep. 22, 2016

Related U.S. Application Data
(60) Provisional application No. 62/221,625, filed on Sep. 22, 2015.
(60) Provisional application No. 62/260,521, filed on Nov. 28, 2015.

(51) Int. Cl. G09B 27/08; G09B 5/02; G09B 1/00

(52) U.S. Cl. CPC G09B 27/08; G09B 1/00; G09B 5/02

(57) ABSTRACT

An intuitive globe that provides an ornamental display piece and/or an interactive learning tool has a sphere casing, a geographical demarcation, a liquid, and a support stand. The support stand holds the sphere casing, wherein the sphere casing is rotatably connected to a sphere mount. The sphere casing is a hollow body that is filled with the liquid and is transparent such that movement of the liquid is visible when the sphere casing is rotated. The geographical demarcation is disposed about the sphere casing, representing a body of land. The geographical demarcation is a first color, while the liquid is a second color; the second color contrasting the first color, such that the geographical demarcation is readily discernable from the liquid. A plurality of touch sensors can be utilized in conjunction with a plurality of lights to illuminate selected regions of the geographical demarcation.

The current application claims a priority to the U.S. Provisional Patent application Ser. No. 62/221,625 filed on Sep. 22, 2015 and the U.S. Provisional Patent application Ser. No. 62/260,521 filed on Nov. 28, 2015.

### FIELD OF THE INVENTION

The present invention relates generally to globes. More specifically, the present invention is an interactive and ornamental globe that can be utilized to present diverse geographical information.

### BACKGROUND OF THE INVENTION

A globe has been a traditional device used to display Earth in a three dimensional space, and is able to most accurately represent the size and spacing of each of the continents. In addition to being utilized as learning tools, globes are often used as ornamental decorations. However, such ornamental embodiments are typically provided as a solid body, and as such the feel for bodies of water is not accurately depicted as there is no movement above or below the surface of the globe as it is rotated.

While globes are great for presenting geographical locations, they are limited in use beyond referencing the latitudinal and longitudinal coordinates of cities, countries, etc. In the current digital age, individuals seek access to a wide range of information across the world, and they often want instantaneous access to such information. Furthermore, individuals prefer user friendly devices that are easy to operate, while still providing a diverse range of functionality. The integration of such technologies into traditional globes is currently lacking.

Therefore it is an object of the present invention to provide an intuitive globe having a hollow, transparent sphere casing that is filled with a liquid. The liquid is a contrasting color to the color of a geographical demarcation disposed about the sphere casing, such that bodies of land and water are visibly discernible. The transparent nature of the sphere casing allows a user to view the moving liquid as the sphere casing is rotated about a support stand. The liquid may also be phosphorescent, allowing the globe to function as a nightlight or attractive nighttime ornament.

It is another object of the present invention to provide an intelligent globe with which a user may interact, wherein a plurality of lights is disposed about the geographical demarcation, allowing a user to illuminate selected regions. The regions can be selected by pressing one of a plurality of touch sensors disposed about the geographical demarcation, or by selecting the region through a personal computing device that is wirelessly connected to the globe. Local information for the selected region can also be presented to the user through a speaker, a display screen, the personal computing device, or a combination thereof.

### BRIEF DESCRIPTION OF THE DRAWINGS

FIG. 1 is a perspective view of the present invention, wherein the sphere casing being a first color is filled with a liquid being a second color; the second color contrasting the first color.

FIG. 2 is a perspective view of the present invention, wherein a plurality of lights is disposed about the geographical demarcation; each of the plurality of lights corresponding to a particular geographical location.

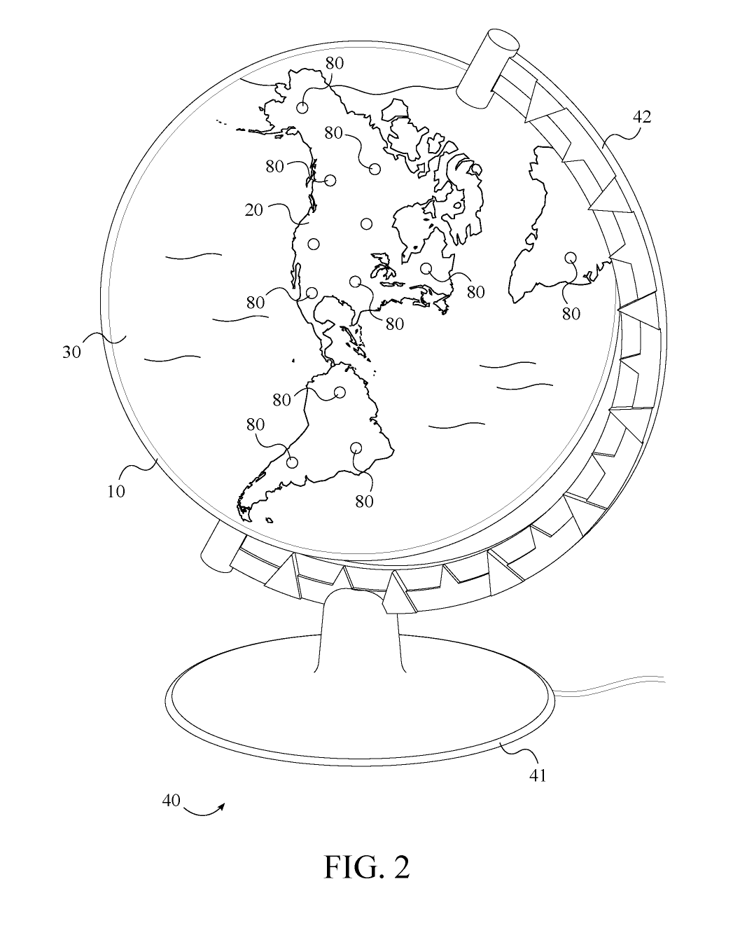

FIG. 3 is a perspective view of the present invention, wherein a plurality of touch sensors is disposed about the geographical demarcation in conjunction with the plurality of lights; each of the plurality of touch sensors corresponding to a particular light.

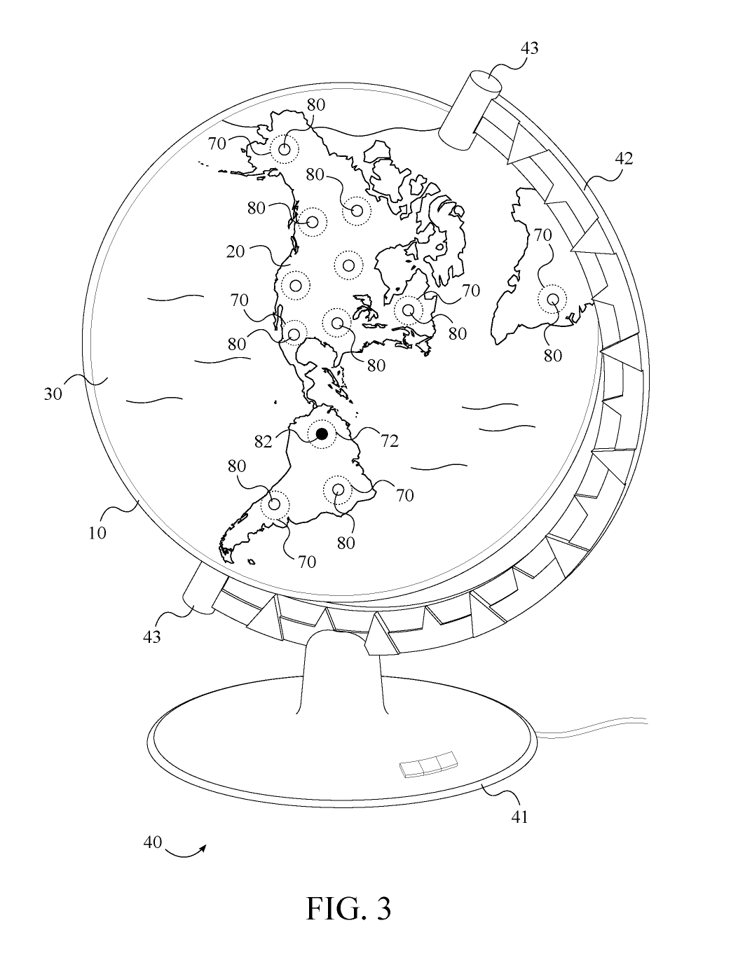

FIG. 4 is a perspective view of the present invention, wherein a particular light is illuminated following the actuation of the particular sensor corresponding to the particular light.

FIG. 5 is a perspective view of the present invention, wherein a phone dock is integrated into the base and a projector is utilized to display the time, date, temperature, etc.

FIG. 6 is a front elevational view depicting an alternative embodiment of the support stand.

FIG. 7 is a front elevational view depicting yet another alternative embodiment of the support stand.

FIG. 8 is a diagram depicting the electrical connections between the processing unit and other components, and a wireless connection between the transceiver and a personal computing device.

### DETAIL DESCRIPTIONS OF THE INVENTION

All illustrations of the drawings are for the purpose of describing selected versions of the present invention and are not intended to limit the scope of the present invention.

The present invention is an intuitive globe that provides an ornamental display piece and/or an interactive learning tool. The present invention is a uniquely-designed, interactive, and multi-functional globe capable of being considered a stylish ornament, an educational tool, and more. The intuitive globe is designed to function as an innovation to the normal or old-fashioned Earth globes, having multiple new features to bring globes into the digital age. While the present invention is described hereinafter in relation to planet Earth, it is to be known that the present invention can be adapted to represent any other planetary body.

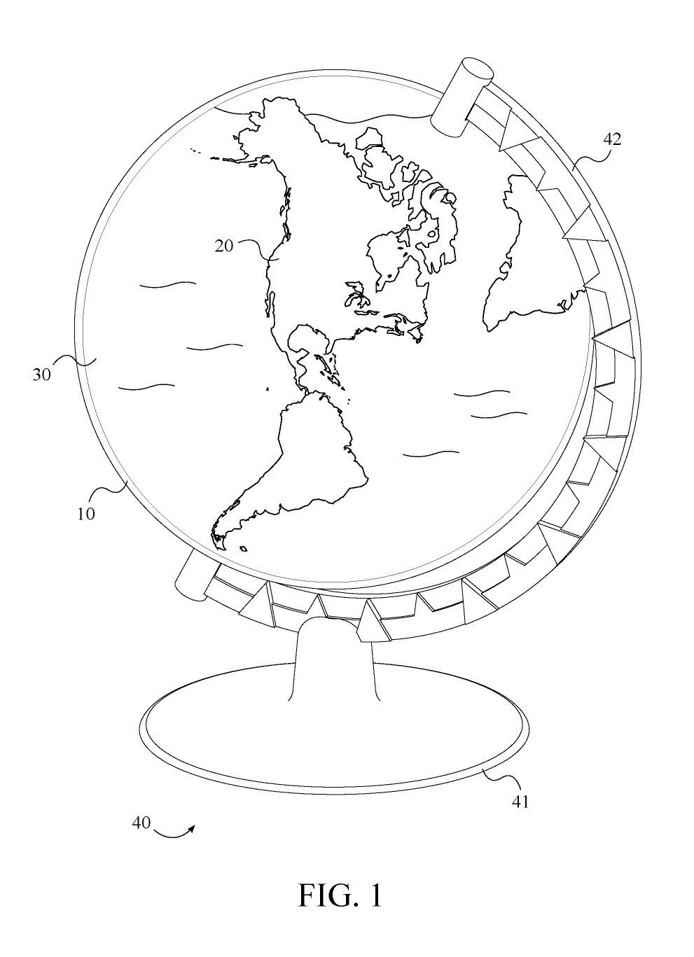

In reference to FIG. 1, the present invention comprises a sphere casing 10, a geographical demarcation 20, a liquid 30, and a support stand 40. The sphere casing 10 provides the traditional globe structure, being a spherical component that is rotatably mounted to the support stand 40. In the preferred embodiment of the present invention, the sphere casing 10 is a hollow structure that is filled with the liquid 30, wherein the liquid 30 represents the bodies of water on Earth. As such, the sphere casing 10 is transparent, allowing individuals to view the liquid 30. Additionally, a portion of the sphere casing 10 remains unfilled, such that the movement of the liquid 30 within the sphere casing 10 is apparent as the sphere casing 10 is rotated.

In further reference to FIG. 1, the geographical demarcation 20 is disposed about the sphere casing 10, wherein the geographical demarcation 20 represents areas of land, such as the seven continents on Earth. The geographical demarcation 20 is opaque, or at least semi-opaque, such that the liquid 30 is either not visible or visibly discernible from the geographical demarcation 20. Furthermore, the geographical demarcation 20 is a first color, while the liquid 30 is a second color; the second color contrasting the first color. For example, the first color may be green, while the second color may be blue, such that the liquid 30 is clearly distinguished from the geographical demarcation 20. The geographical demarcation 20 may be a two dimensional land representation disposed about the sphere casing 10, or the geographical demarcation 20 can be a three dimensional land representation, extending out from the sphere casing 10.

In some embodiments of the present invention, the second color is phosphorescent, such that the liquid 30 glows in the dark. Any phosphorescent color may be utilized, however, a blue color is preferred. The phosphorescent nature of the second color allows the present invention to function as a night light or ornamental light device that can add to the ambiance of a room, similar to that of a lava lamp.

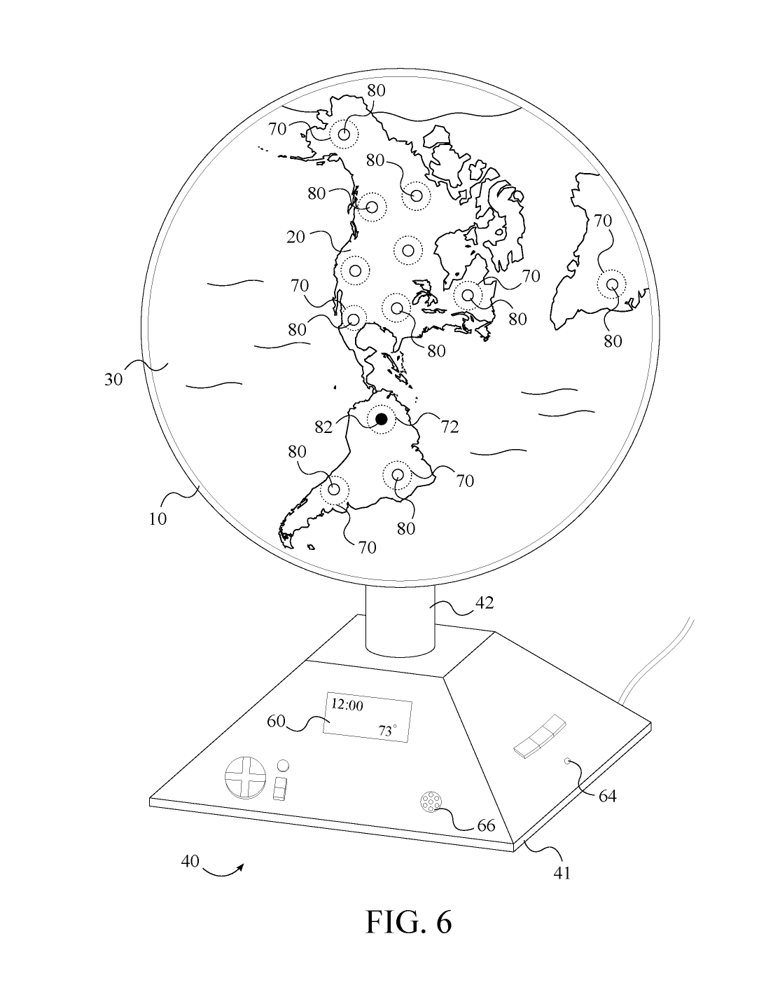

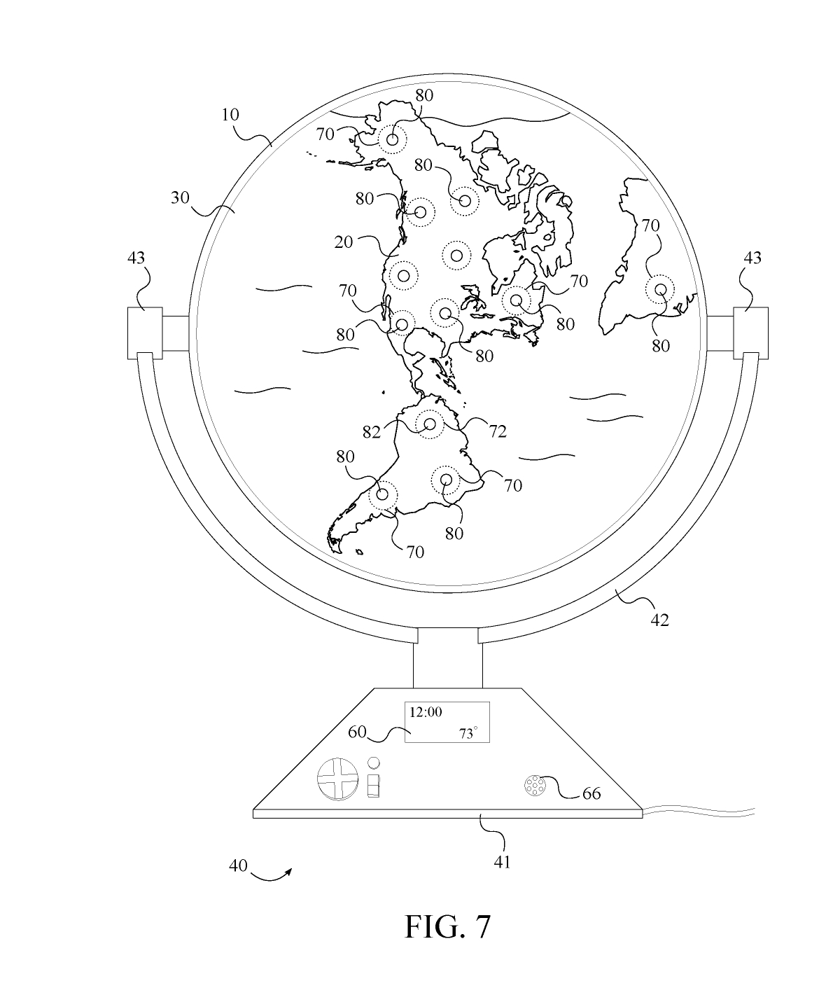

In reference to FIG. 1 and FIG. 6-7, the support stand 40 comprises a base 41 and a sphere mount 42, wherein the sphere mount 42 is adjacently connected to the base 41. The base 41 is designed to stabilize the sphere mount 42 and the sphere casing 10, preventing the present invention from toppling over. The base 41 may be weighted or designed with a large surface area to distribute the weight of the sphere mount 42, the sphere casing 10, and the liquid 30. The sphere mount 42 comprises a rotational device 43 to which the sphere casing 10 is rotatably engaged. The rotational device 43 can be a mechanical device, a magnetic device, or a combination thereof. In basic configurations, the rotational device 43 allows the sphere casing 10 to be rotated by hand, however, in more complex configurations, the rotational device 43 controls the precise movement and positioning of the sphere casing 10.

In one embodiment, the rotational device 43 comprises a shaft the traverses through the sphere casing 10, wherein each end of the shaft is rotatably mounted to a frame of the sphere mount 42. A servo motor or similar device can then be used to rotate the shaft. In another embodiment, the rotational device 43 comprises a first shaft and a second shaft, wherein the first shaft and the second shaft are terminally fixed to the sphere casing 10, opposite each other. The first shaft and the second shaft are then rotatably mounted to the frame, allowing the sphere casing 10 to rotate, wherein one or more motors may allow the first shaft and the second shaft to rotate. In yet another embodiment, the rotational device 43 comprises one or more electromagnets that engages with one or more permanent magnets affixed to thee sphere casing 10. A current can be run through the electromagnet, causing the sphere casing 10 to be rotated due to the magnetic force between the electromagnet and the permanent magnet.

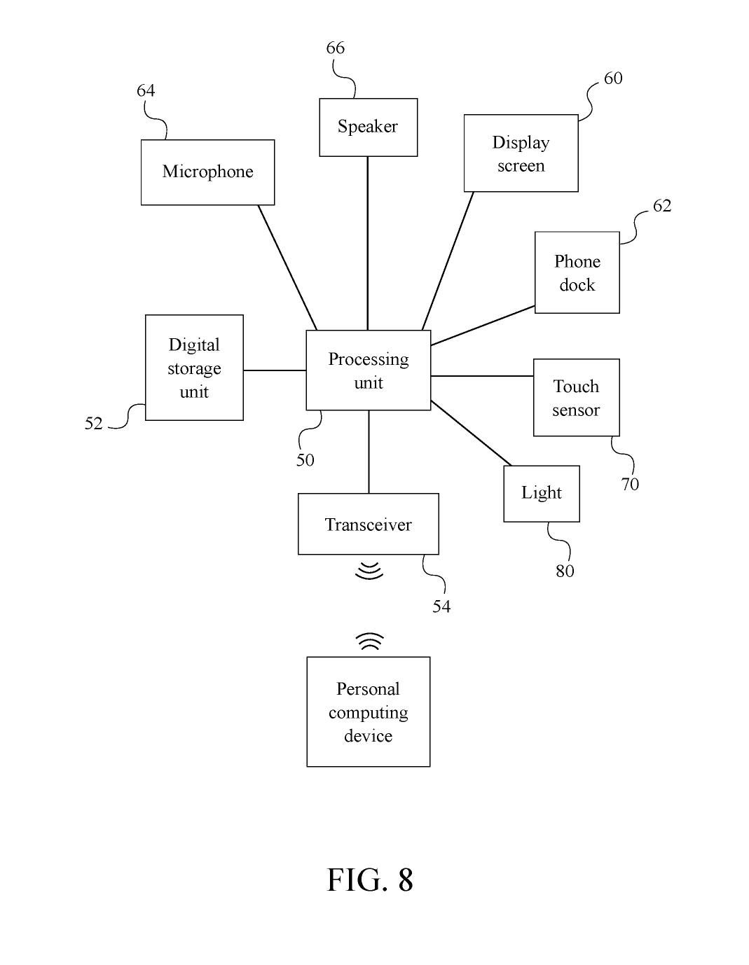

In more complex embodiments, the present invention further comprises a processing unit 50 and a digital storage unit 52 and any of a display screen 60, a plurality of touch sensors 70, a plurality of lights 80, a phone dock 62, a transceiver 54, a microphone 64, or a speaker 66. The processing unit 50 is electrically connected to the digital storage unit 52 as depicted in FIG. 8, wherein both the processing unit 50 and the digital storage unit 52 are mounted within the base 41. The processing unit 50 controls the other electrical components, interprets incoming signals, and accesses data stored on the digital storage unit 52. The digital storage unit 52 may comprise any type of computer data storage hardware. It is also possible for both the processing unit 50 and the digital storage unit 52 to be integrated into a single chip.

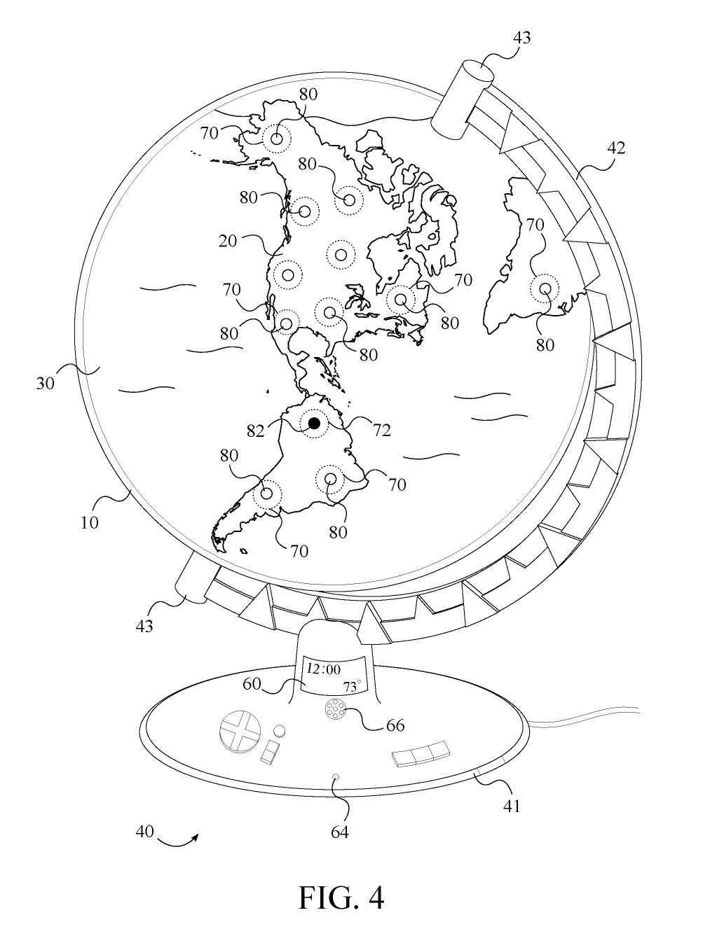

In one embodiment, the processing unit 50 and the data storage unit are used in conjunction with the display screen 60 in order to provide the functionality of an alarm clock. In reference to FIG. 4, the display screen 60 is mounted into the base 41 and prominently presents the time, date, temperature, etc. to the user. The data storage unit is used to keep the time, while the processing unit 50 dictates the presentation of the display screen 60. Alarm times may be saved onto the digital storage unit 52, wherein the processing unit 50 sounds the alarm at the designated time via the speaker 66; the speaker 66 also being mounted into the base 41 as depicted in FIG. 4. The processing unit 50 may also be configured to calculate the current time for a different time zone. For example, if the present invention is located in England, the user can select a time zone in Asia, wherein the processing unit 50 adjusts the current time presented through the display screen 60 accordingly.

A projector may also be integrated into the base 41, and may be used standalone or in conjunction with the display screen 60. The projector allows information such as the time, date, temperature, etc. to be projected onto a wall, ceiling, or other desirable surface. The projector may even be configured to display the desired information in the air (e.g. a hologram). Control buttons can also be integrated into the base 41 to control the information that is depicted by the projector or the display screen 60, set alarms, or simply turn the projector or the display screen 60 on and off. Additional control buttons may also be provided to control the rotation of the sphere casing 10 in embodiments where the rotational device 43 is implemented

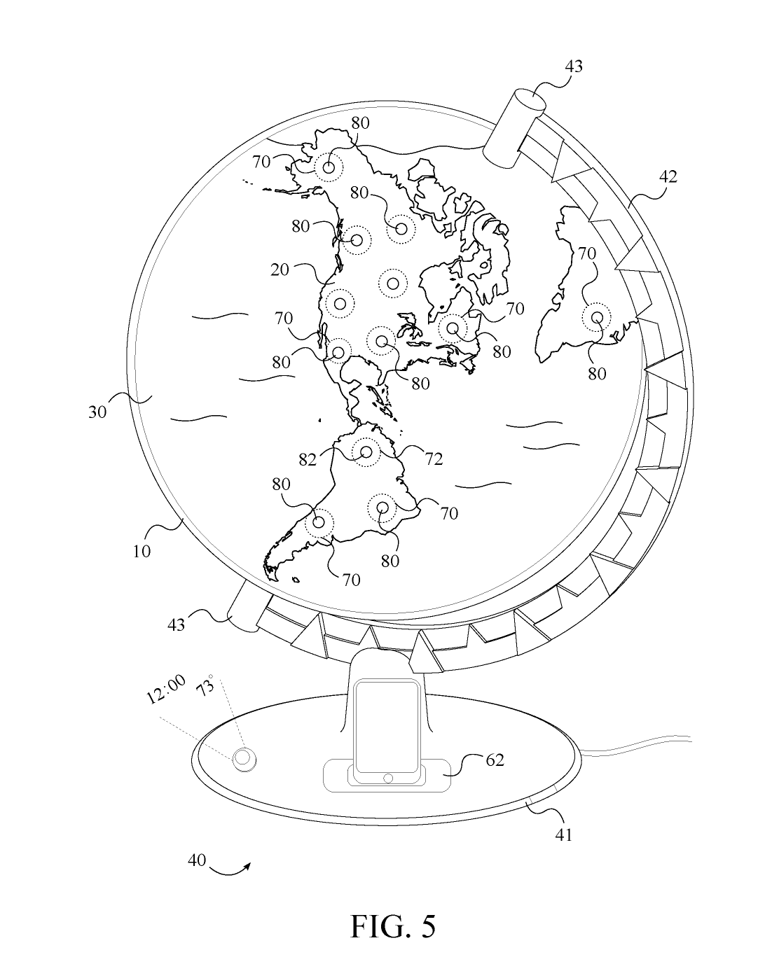

In reference to FIG. 5, the plurality of touch sensors 70 is disposed about the geographical demarcation 20, wherein each of the plurality of touch sensors 70 corresponds to a particular geographical location 21 presented on the geographical demarcation 20. For example, a touch sensor may be positioned at the most popular cities within a country, such as New York City, Chicago, or Los Angeles. Each of the plurality of touch sensors 70 is capable of detecting the presence of a user's finger or hand. The plurality of touch sensors 70 may include the use of pressure sensors, light sensors, or anything other type of touch sensor capable of detecting human touch.

The plurality of touch sensors 70 is used in conjunction with the processing unit 50 and either the digital storage unit 52 or the transceiver 54. The digital storage unit 52 can be utilized to store geographical data associated with the particular geographical location 21. The geographical data may include landmark information, a history of the surrounding area, or any other pertinent information concerning the particular geographical location 21. The processing unit 50 is configured to retrieve the geographical data from the digital storage unit 52 in response to the actuation of a particular sensor 72 from the plurality of touch sensors 70. For example, if the user touches the particular sensor 72 associated with the particular geographical location 21 being New York City, then the geographical data presented would pertain to New York City. The geographical data can be presented to the user through the display screen 60 or the speaker 66.

When used with the transceiver 54, the processing unit 50 retrieves the geographical data through the transceiver 54 in response to the actuation of the particular sensor 72. In this way, the geographical data can be gathered from one or more third party websites, databases, etc. The third party from which the geographical data is retrieved may be preset by the manufacturer or determined by the user, wherein user settings are saved on the digital storage unit 52. The use of the transceiver 54 also allows real-time information to be retrieved for a particular city or region, such as the temperature, weather forecast, current news events, etc.

Furthermore, the transceiver 54 can be used to connect to personal computing device, such as a laptop, smartphone, or tablet as depicted in FIG. 8. This allows more detailed visual information to be shared with the user and allows the user to then share such information with other individuals. For example, if the user touches the particular sensor 72 associated with Chicago, then news articles, photos, videos, etc. of Chicago will be retrieved and forwarded to the personal computing device via the transceiver 54.

In some embodiments, the user can change the position of the sphere casing 10 by selecting the particular geographical location 21 through the personal computing device. In such an embodiment, the processing unit 50 is able to detect the current rotational position of the sphere casing 10, while the digital storage device stores the particular geographical location 21, along with a designated radial angle for the particular geographical location 21. When the user selects the particular geographical location 21 through the personal computing device, or alternatively through the particular sensor 72, the processing unit 50 actuates the rotational device 43 in order to position the particular geographical location 21 at the designated radial angle, such that the particular geographical location 21 is prominently displayed to the user. In some embodiments, the transceiver 54 and processing unit 50 may be able to detect the exact location of the personal computing device and present the particular geographical location 21 accordingly.

In reference to FIG. 4-5, the plurality of lights 80 is utilized to illuminate designated areas of the geographical demarcation 20, wherein each of the plurality of lights 80 corresponds to a particular geographical location 21 indicated by the geographical location. As such, the plurality of lights 80 is disposed about the geographical demarcation 20. The plurality of lights 80 can be recessed into the geographical demarcation 20 or the sphere casing 10, or otherwise integrated into the geographical demarcation 20 or the sphere casing 10. When used in conjunction with the plurality of touch sensors 70, each of the plurality of touch sensors 70 corresponds to a particular light 82 from the plurality of lights 80. Meanwhile, the processing unit 50 is configured to illuminate the particular light 82 in response to the actuation of a particular sensor 72 from the plurality of sensors as depicted in FIG. 4-5; the particular sensor 72 corresponding to the particular light 82.

The plurality of lights 80 can also be used in conjunction with the transceiver 54, wherein the transceiver 54 receives an indicator command from the personal computing device; the indicator command corresponding to the particular geographical location 21 selected by the user. The transceiver 54 relays the indicator command to the processing unit 50,wherein the processing unit 50 illuminates the particular light 82 that corresponds to the particular geographical location 21 according to the indicator command.

In reference to FIG. 4, the microphone 64 is mounted into the base 41 and allows for the voice actuation of the processing unit 50. Voice commands may be pre-programmed or set by the user, wherein the voice commands are stored on the digital storage unit 52. Upon receiving a voice command through the microphone 64, the processing unit 50 analyzes the voice command and proceeds to carry out the associated action. The voice command can be as simple as naming a specific city, or can be a more complex command for retrieving data, setting an alarm, etc. For example, the voice command could simply be “Los Angeles”, wherein the particular light 82 for Los Angeles is illuminated and the geographical data for Los Angeles is presented when the user says the city name. As another example, the voice command could be “set time”, wherein the processing unit 50 goes into an alarm setting mode and the user can proceed to issue further voice commands to set the specific time and date for the alarm.

In reference to FIG. 5, the phone dock 62 is mounted into the base 41 and allows the user to connect a phone or similar portable device to the base 41. The phone dock 62 can be configured to provide a power connection and/or a data connection with the attached device. The power connection allows the phone to charge, while the data connection allows the user to control the processing unit 50 and access the digital storage unit 52 via the phone. Alternatively, the data connection can be provided through a port, such as a universal serial bus connector, wherein the phone can be connected to the present invention via a cable. Similarly, the power connection to the phone may also be provided through a cable.

While the preferred embodiment of the present invention includes the liquid 30, the liquid 30 may be undesirable for some embodiments, and as such may be omitted from the design of the present invention. This may be done to overcome manufacturing challenges, provide a more diverse range of products, or for any other necessary or desired reason. Without the liquid 30, the sphere casing 10 may a hollow or solid body.

Although the invention has been explained in relation to its preferred embodiment, it is to be understood that many other possible modifications and variations can be made without departing from the spirit and scope of the invention as hereinafter claimed.

What is claimed is:

1. An interactive globe comprises:
a sphere casing;
a geographical demarcation;
a liquid;
a support stand;
the support stand comprising a base and a sphere mount;
the sphere mount being adjacently connected to the base;
the sphere casing being rotatably connected to the sphere mount;
the sphere casing being filled with the liquid;
the geographical demarcation being disposed about the sphere casing;
the geographical demarcation being a first color;
the liquid being a second color;
the second color contrasting the first color; and
the sphere casing being transparent.

2. The interactive globe as claimed in claim 1 comprises:
the second color being phosphorescent.

3. The interactive globe as claimed in claim 1 comprises:
a display screen; and
the display screen being mounted into the base.

4. The interactive globe as claimed in claim 1 comprises:
a plurality of touch sensors;
the plurality of touch sensors being dispersed about the geographical demarcation; and
each of the plurality of touch sensors corresponding to a particular geographical location on the geographical demarcation.

5. The interactive globe as claimed in claim 4 comprises:
a processing unit and a digital storage unit;
the digital storage unit being configured to store geographical data associated with a particular geographical location indicated by the geographical demarcation; and
the processing unit being configured to retrieve the geographical data in response to the actuation of a particular sensor from the plurality of touch sensors.

6. The interactive globe as claimed in claim 4 comprises:
a processing unit and a transceiver; and
the processing unit being configured to retrieve geographical data associated with the particular geographical location through the transceiver in response to the actuation of a particular sensor from the plurality of touch sensors.

7. The interactive globe as claimed in claim 1 comprises:
a phone dock; and
the phone dock being mounted into the base.

8. The interactive globe as claimed in claim 1 comprises:
the sphere casing comprising a rotational device; and
the sphere casing being engaged with the rotational device.

9. The interactive globe as claimed in claim 8, wherein the rotational device is a mechanical device.

10. The interactive globe as claimed in claim 8, wherein the rotational device is a magnetic device.

11. The interactive globe as claimed in claim 8 comprises:
a processing unit and a digital storage unit;
the digital storage unit being configured to store a particular geographical location indicated by the geographical demarcation; and
the processing unit being configured to actuate the rotational device in order to position the particular geographical location at a designated radial angle.

12. The interactive globe as claimed in claim 1 comprises:
a microphone; and
the microphone being mounted into the base.

13. The interactive globe as claimed in claim 1 comprises:
a speaker; and
the speaker being mounted into the base.

14. The interactive globe as claimed in claim 1 comprises:
a plurality of lights;
the plurality of lights being disposed about the geographical demarcation; and
each of the plurality of lights corresponding to a particular geographical location on the geographical demarcation.

15. The interactive globe as claimed in claim 14 comprises:
a processing unit and a plurality of touch sensors;
each of the plurality of touch sensors corresponding to a particular light from the plurality of lights; and
the processing unit being configured to illuminate the particular light in response to the actuation of a particular sensor from the plurality of touch sensors.

16. The interactive globe as claimed in claim 14 comprises:
a processing unit and a transceiver;
the transceiver being configured to relay an indicator command to the processing unit; and
the processing unit being configured to illuminate a particular light from the plurality of lights according to the indicator command.
